(19) United States
(12) Patent Application Publication
(10) Pub. No.: US 2009/0077182 A1
(43) Pub. Date: Mar. 19, 2009

(54) SYSTEM AND METHOD FOR IDENTIFYING EMAIL CAMPAIGNS

(75) Inventors: Ketan Banjara, Mountain View, CA (US); Scott A. Sachtjen, San Jose, CA (US)

Correspondence Address: SCHWEGMAN, LUNDBERG & WOESSNER, P.A., P.O. BOX 2938, MINNEAPOLIS, MN, 55402, US

(73) Assignee: Iconix, Inc, Santa Clara, CA (US)

(21) Appl. No.: 11/856,693

(22) Filed: Sep. 17, 2007

(51) Int. Cl. G06F 15/16

(52) U.S. Cl. 709/206

(57) ABSTRACT

A system and method for identifying email campaigns. A first embodiment uses an email client local to email recipients to report email header back to an email monitor server application. The email analysis server application compares the email header information received from many sources and identifies email messages having substantially similar from addresses, subjects and dates as being part of a single email campaign. In a second embodiment, an email monitor program in a mail server local to email recipients is used to report back email header information.

### TECHNICAL FIELD

The present invention relates to the internet communication. In particular, but not by way of limitation, the present invention discloses techniques for identifying internet email campaigns.

### BACKGROUND

The global internet has become a mass media on par with radio and television. As a mass media, it has become an invaluable tool for companies wishing to advertise and directly communicate to customers. In order to be able to provide the most internet efficient advertising, companies need to be able to assess the effectiveness of any internet-based advertising campaign.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 illustrates a diagrammatic representation of machine in the example form of a computer system within which a set of instructions, for causing the machine to perform any one or more of the methodologies discussed herein, may be executed.

FIG. 2A conceptually illustrates an example use of internet-based email.

FIG. 2B illustrates the internet email scenario of FIG. 2A wherein a user has sent out an email message to multiple recipients as part of an email campaign.

FIG. 2C illustrates the email campaign scenario of FIG. 2B wherein a mail client on the computer system of email recipient reports information to an email monitor server application.

FIG. 2D illustrates an alternate embodiment of the email campaign scenario of FIG. 2C wherein a mail monitor program on a mail server local to the email recipients reports information to an email monitor server application.

3A illustrates an example field scoring graph for the “From:” field for a fuzzy logic embodiment.

3B illustrates an example field scoring graph for the “Subject:” field for a fuzzy logic embodiment.

3C illustrates an example field scoring graph for the “Date:” field for a fuzzy logic embodiment.

### DETAILED DESCRIPTION

The following detailed description includes references to the accompanying drawings, which form a part of the detailed description. The drawings show illustrations in accordance with example embodiments. These embodiments, which are also referred to herein as “examples,” are described in enough detail to enable those skilled in the art to practice the invention. It will be apparent to one skilled in the art that specific details in the example embodiments are not required in order to practice the present invention. For example, although the example embodiments are mainly disclosed with reference to email systems that use the Simple Mail Transport Protocol (SMTP), the teachings can be used with other types of email protocols or other types of electronic communication systems. The example embodiments may be combined, other embodiments may be utilized, or structural, logical and electrical changes may be made without departing from the scope what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive or, such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

Computer Systems

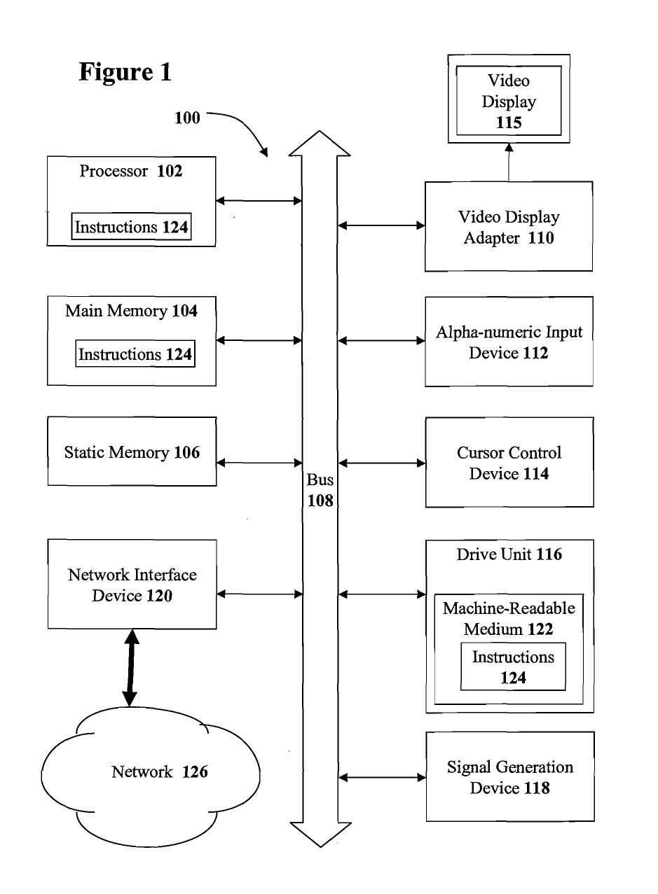

FIG. 1 illustrates a diagrammatic representation of a machine in the example form of a computer system 100 within which a set of instructions 124, for causing the machine to perform any one or more of the methodologies discussed herein, may be executed. In alternative embodiments, the machine may operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network server, a network router, a network switch, a network bridge, or any machine capable of executing a set of instructions (sequential or otherwise) that specify actions to be taken by that machine. Further, while only a single machine is illustrated in FIG. 1, the term “machine” shall also be taken to include any collection of machines that individually or jointly execute a set (or multiple sets) of instructions to perform any one or more of the methodologies discussed herein.

The example computer system 100 illustrated in FIG. 1 includes a processor 102 (e.g., a central processing unit (CPU), a graphics processing unit (GPU) or both), a main memory 104 and a static memory 106, which communicate with each other via a bus 108. The computer system 100 may further include a video display adapter 110 that drives a video display system 115 such as a Liquid Crystal Display (LCD) or a Cathode Ray Tube (CRT). The computer system 100 also includes an alphanumeric input device 112 (e.g., a keyboard), a cursor control device 114 (e.g., a mouse or trackball), a disk drive unit 116, a signal generation device 118 (e.g., a speaker) and a network interface device 120.

The disk drive unit 116 includes a machine-readable medium 122 on which is stored one or more sets of computer instructions and data structures (e.g., instructions 124 also known as ‘software’) embodying or utilized by any one or more of the methodologies or functions described herein. The instructions 124 may also reside, completely or at least partially, within the main memory 104 and/or within the processor 102 during execution thereof by the computer system 100, the main memory 104 and the processor 102 also constituting machine-readable media.

The instructions 124 may further be transmitted or received over a network 126 via the network interface device 120 utilizing any one of a number of well-known transfer protocols (e.g., FTP).

While the machine-readable medium 122 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies described herein, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

For the purposes of this specification, the term “module” includes an identifiable portion of code, computational or executable instructions, data, or computational object to achieve a particular function, operation, processing, or procedure. A module need not be implemented in software; a module may be implemented in software, hardware/circuitry, or a combination of software and hardware.

Internet Email Transport

Although individual computer systems are powerful tools on their own, the usefulness of computer systems is greatly increased when the computer systems are coupled together in networks. When computers are coupled in local networks, the computer systems can share data and resources such as printers and scanners. Computer networks have been coupled together to created a global computer network known as the internet.

One of the simplest and most useful applications of the internet is electronic mail known simply as email. Email allows a computer system to send a message to one or more other computer systems coupled to the internet.

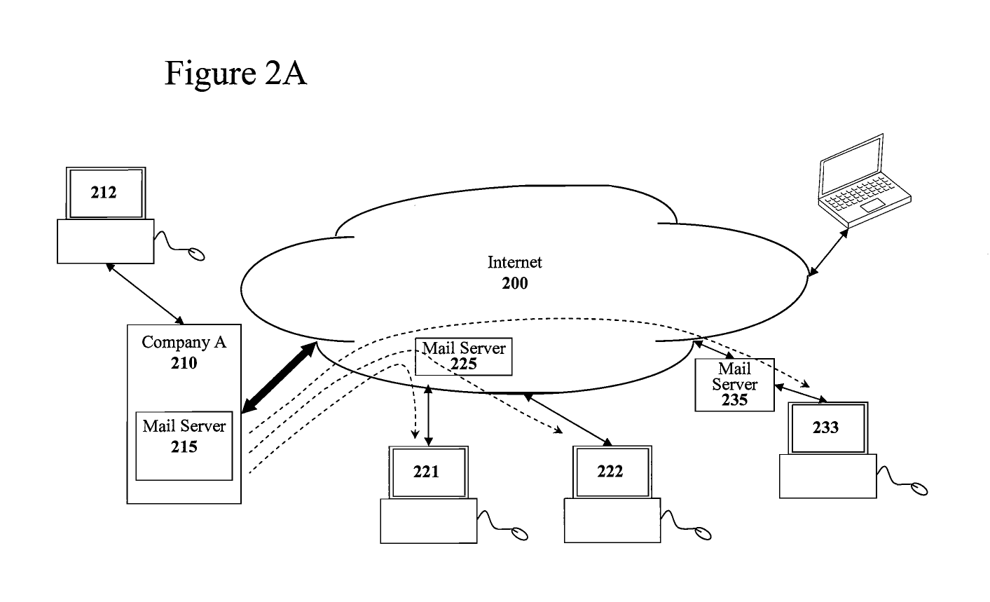

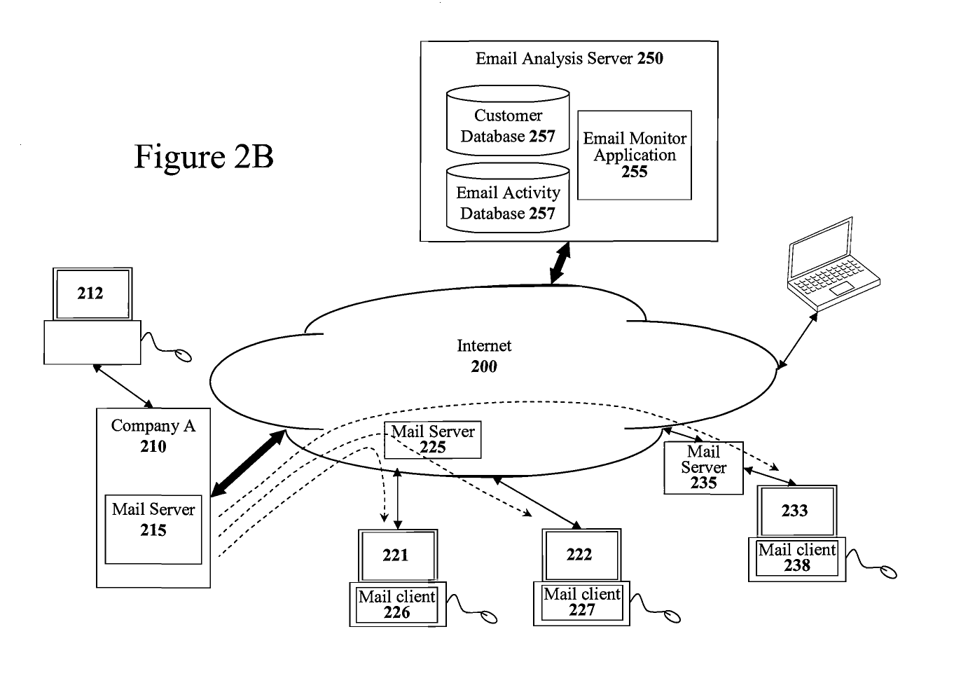

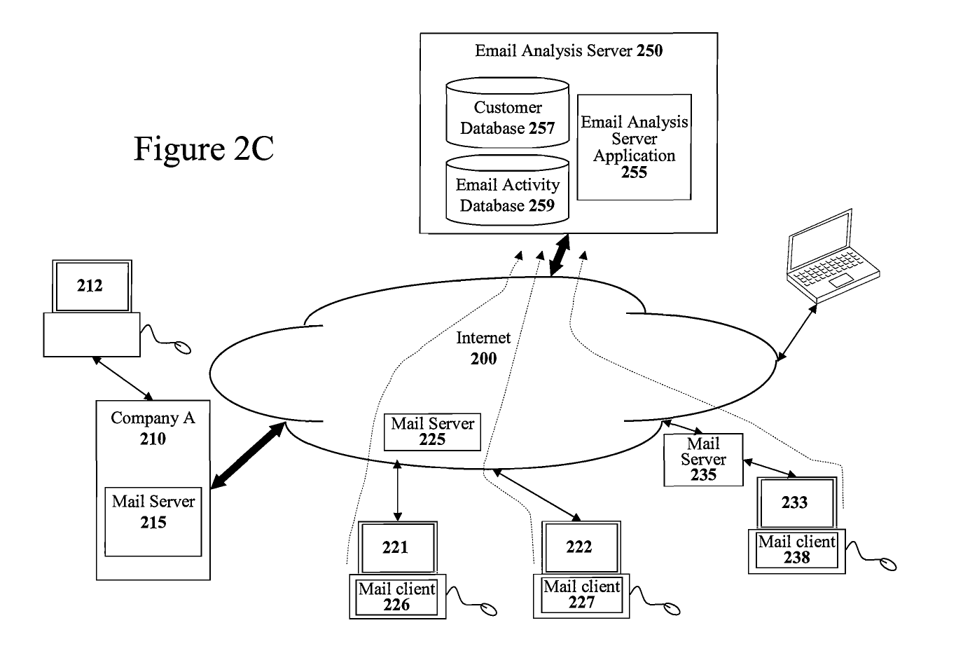

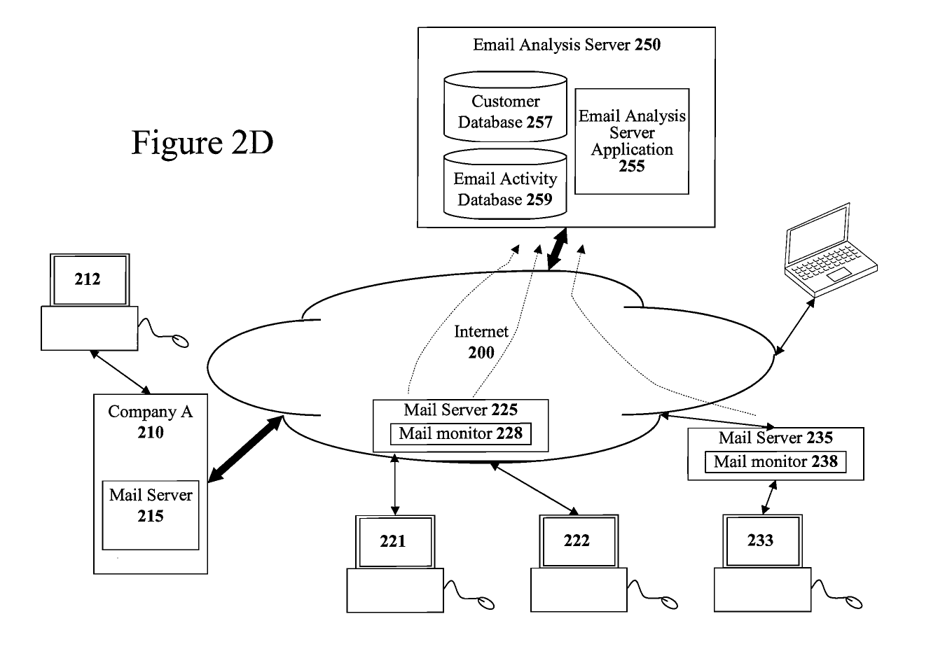

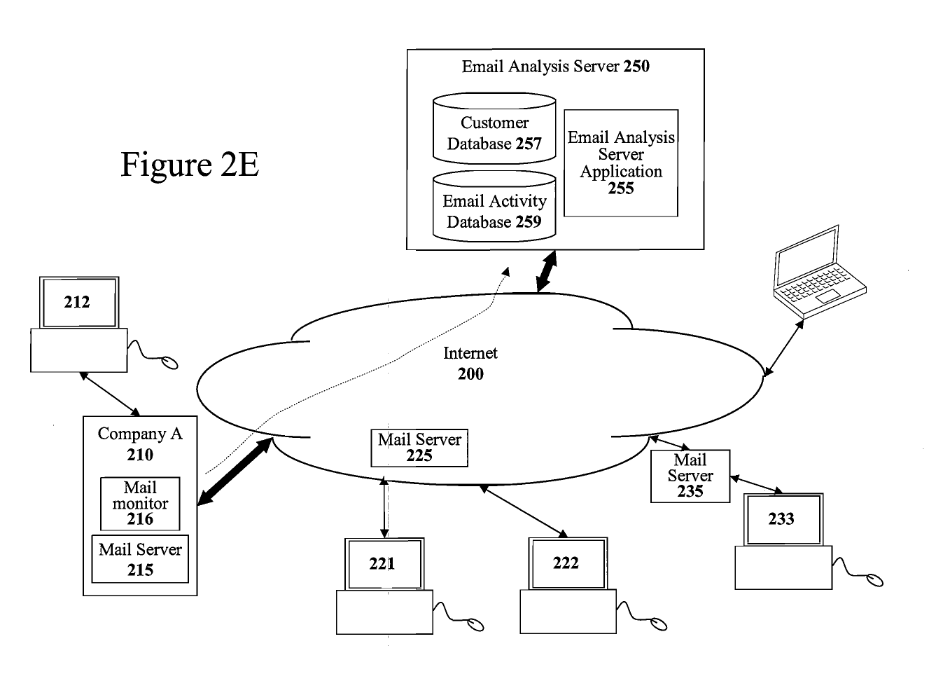

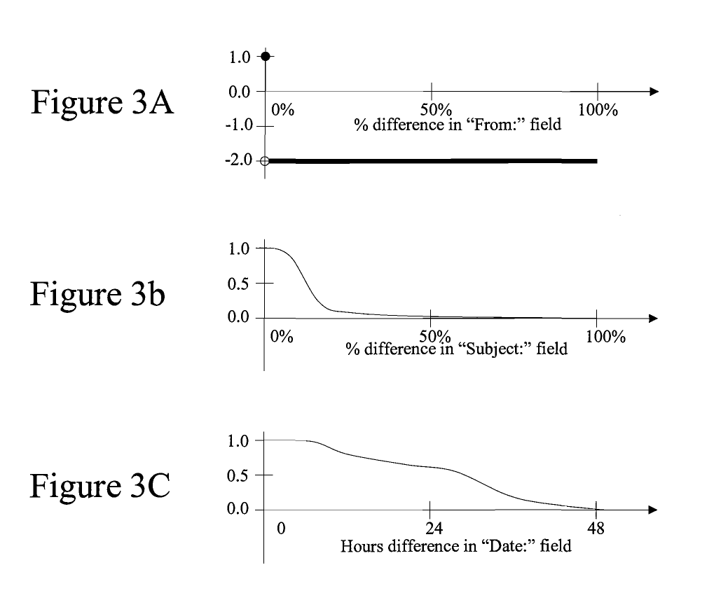

FIG. 2A illustrates an example use of internet based email. Referring to FIG. 2A, a person at computer system 212 may compose an email message to send to multiple users including users of computer systems 221, 222, and 233. When the person at computer system 212 completes the email message and sends it, the email message is transported to that user's mail server 215.

Mail server 215 parses the header information on the email message to determine where to send the email message. All internet email messages (SMTP messages) have 2 major sections: the headers and the body. The body is the content of the message and targeted to the recipient of the email. The headers are targeted to the applications handling the delivery of the email. The format of internet email headers is fully disclosed in the Internet Engineering Task Force (IETF) Request for Comments (RFC) document 2822. After parsing the internet email headers, email server 215 then delivers the email message to email servers used by the users of computer systems 221, 222, and 233. In this example, mail server 215 sends to the email message to mail server 225 and mail server 235.

Users of computer systems 221, 222, and 233 will then access the email messages by accessing their local mail server. Local email client programs on computer systems 221, 222, and 233 may create local copies of the email message. Alternatively, the users of computer systems 221, 222, and 233 may use a web server-based email system that allows a user to access email on a mail server using a standard web browser on the local computer system.

Email Campaigns

An internet user (or an automated email sending system) may send an email message to many different recipients. Such an email sent to many different recipients may be referred to as an “email campaign”. An email campaign is usually done with a specific purpose in mind and sent out a specific target set of recipients. Each email campaign is carefully planned with content creation, selection of target users, inclusion of advertisements, etc.

When an internet user creates an email campaign, it is important to be able to measure the effectiveness of that email campaign. For example, of the number of people who were sent an email message, how many of them opened it?

There are two common methods currently used for measure email campaign success: embedded images and X-header usage. However, both of these current methods have significant downsides.

The embedded image technique takes advantage of the fact that HTML formatted email allows the display of images within the content of the message. The images may be embedded using a link to an external web server that hosts the actual image. When the HTML formatted email is opened, the email client calls the image hosting web server asking for the image. The hosting server serves the image and makes a note doing so. In this manner, the access to the image on the web server acts as a confirmation that the email was opened. The embedded image may be hidden by using a small 1 pixel by 1pixel transparent image.

This embedded image technique has significant limitations. Firstly, it only works for HTML formatted email and does not work with plain text email. Furthermore, it cannot be used to confirm that the email was delivered successfully since it requires the email to be opened. Finally, many email clients block the download of images embedded within an email message. This is done to prevent mass senders of unsolicited email (known as spammers) from knowing when they have successfully delivered a message.

An alternative method that is currently used is the use of special custom headers within an email message. RFC 2822 covering the format of internet email headers allows for custom headers to be inserted into internet email messages. These custom headers, commonly called X-headers because they all begin with ‘X-’, may be used by email applications for their own proprietary purposes. An email sender may add an X-header that identifies the sending company and perhaps also the email campaign. The email sender may then ask the internet service provider (ISP) of the mail recipient if the ISP blocked any emails with a specified X-header. Alternatively, the sender may maintain its own set of email accounts with all the major ISPs and include these email addresses in their email campaign. The sender may then use those email accounts as samples to see if the email campaign messages were delivered to those email accounts.

This X-header based system has its own significant limitations. Firstly, the X-header system requires coordinated work between several entities: the email sender, the ISPs of the recipients, and often a specialized company email Delivery Services Provider (DSP), employed by the email sending company. All parties need to be informed about the content of the X-header in advance of the email campaign. It is very cumbersome to share the X-header for each campaign in advance of each email campaign. Furthermore, this system measures deliverability only in that it only specifies when email messages are delivered to the inbox. One cannot determine if these email messages were opened or simply diverted to a spam folder. With the test email account system, the system only provides a statistical result derived from a small sample of email addresses.

Email Campaign Tracking Using Standard Headers

The present invention discloses a system and method of tracking email campaigns that uses standard internet headers that are available in every internet email message. The disclosed system and method may be implemented in many different embodiments as will be set forth.

FIG. 2B illustrates an internet email scenario similar to the one presented in FIG. 2A with some teachings of one embodiment of present invention introduced. Like the scenario of FIG. 2A, a person at computer system 212 may compose an email message to send to multiple users including users of computer systems 221, 222, and 233.

In one embodiment, the users view the email in a manner that activates a special mail client program (226, 227, and 238) on their system. The mail client may be an add-on to a formal mail client program such as Microsoft Outlook. In another embodiment, the mail client may be a helper application in a web browser for users that access email using a web based email system.

Referring to FIG. 2C, when the mail client detects a new email message, the mail client may contact an email analysis server application 255 in an email monitoring server 250 to pass along information about the new email message, such as email header information, to the email analysis server application 255. The email analysis server application 255 may be implemented as a web service. In one embodiment, the system passes information from the “Subject:” field, the “From:” field, and the “Date:” field. In this embodiment and in later embodiments to be disclosed, the information may be transferred from the email client to the email analysis server application 255 in a secure manner as is well-known in the art. In one embodiment, an encrypted tunnel is used. The secure transfer prevents access to the email analysis server application 255 by unauthorized programs and maintains privacy. The email analysis server application 255 will process that data as will be set forth later in this document.

In another embodiment, the mail client program (226, 227, and 238) sends limited information about a batch of email messages to the email analysis server application 255 in a single communication. The limited information may consist only of fields associated with the origin of the email messages such as the “From:”, “Sender:”, and “Reply-To:” fields. In this manner, the system reduces the amount of network bandwidth consumed. The email analysis server application 255 may then consult customer database 257 to determine which email messages the email analysis server application 255 is interested in. The email analysis server application 255 may then reply with a response as to which particular email messages the email analysis server application 255 is interested in and what should be done with those email messages. The client email program may then send the “Subject:” field, the “From:” field, and the “Date:” field to the email analysis server application 255 from the specified messages.

In one embodiment, the mail client program performs additional functions. For example, in one embodiment the mail client program authenticates the specified messages to inform the user that the email message is from the actual sender that claims to be sending the email. The authentication may be performed using the techniques set forth in IETF RFC 4406, 4408, 4881, or using any other similar techniques. After performing the authentication, the mail client program may return the header information (the “Subject:” field, the “From:” field, and the “Date:” field) along with the results of the attempt to authenticate the email message. The results of this authentication may be tracked as part of the campaign results as will be described later.

Email Campaign Tracking Using Standard Headers

As set forth in the preceding section, the information gathered and transmitted for identifying campaigns is standard header information. Specifically, one embodiment transmits the “Subject:” field, the “From:” field, and the “Date:” field information. It should be noted that this information is available at any point in the email chain and thus different implementations may transmit this information from different points of the email chain.

FIG. 2D illustrates a first alternate embodiment wherein an email monitor program (228 and 238) at the recipient's email server (225 and 235) handles the function of the mail client program in the previous embodiment. The mail monitor (228 and 238) may simply report the needed header information the email analysis server application 255 for every email message received.

Alternatively, the mail monitor (228 and 238) may group together information on many email messages and send a batch message to email analysis server application 255 requesting the email analysis server application 255 to specify which email messages it is interested in. The email analysis server application 255 could respond with a list of which email messages it is interested in and what should be done with those email messages. The mail monitor (228 and 238) would then provide the needed header information to the email analysis server application 255.

With an embodiment with a mail monitor based at the recipient's email server (225 and 235), the mail monitor can still provide authentication service for the email recipients. Thus, the mail monitor (228 and 238) could send a batch message to email analysis server application 255 identifying several email messages and requesting the email analysis server application 255 to specify which email messages it is interested in. The email analysis server application 255 would respond with a list of which email messages it is interested in and what should be done with those email messages. The mail monitor (228 and 238) could then perform an authentication and provide the results of the authentication and the needed header information back to the email analysis server application 255 at the same time.

FIG. 2E illustrates another alternate embodiment wherein an email monitor program 216 located at the sender's email server 215. In the embodiment of the FIG. 2D, the email monitor program 216 may send the email header information individually to the email analysis server application 255. Alternatively, the email monitor program 216 located at the sender's email server 215 could send a batch message identifying several email messages and to email analysis server application 255 requesting the email analysis server application 255 to specify which email messages it is interested in. Upon receiving a response, the email monitor program 216 would then send additional information about the specified email messages to the email analysis server application 255. Note that it would not make much sense for the email monitor program 216 located at the sender's email server 215 verify the authentication of messages.

Email Campaign Tracking Data Analysis

As set forth in the preceding sections, various different pieces of SMTP email header information are transmitted to the email analysis server application 255. If it has not already occurred, email analysis server application 255 may consult customer database 257 to determine if the email analysis server application 255 is interested in the email header information. If the email header information is not from a message sent by an email tracking customer of the email analysis server 250 listed in customer database 257 then email analysis server application 255 may discard that email header information. The email analysis server application 255 may store that information in email activity database 257.

The email analysis server application 255 stores the headers received in email activity database 257 (along with any other information collected). Each header, in its entirety, could be stored in its own database field. Alternatively, the email analysis server application 255, can break up each header into parts, and store each part in its own database field. For example, the text string in the Subject: header can be broken down into words, and each word is stored in its own field.

When the system analyzes the email header information, the system determines if the email header information for a particular email message is different than all the other email headers that have already been received. If an email header is different than all the previously seen email headers then the email analysis server application 255 marks the message as belonging to a new email campaign. The email headers for that email message are then stored to be used to identify additional email messages in the same campaign. The email headers may be stored in a raw format as received or in a parsed format that is more ideal for performing the comparisons.

In one embodiment, the “Subject:” field from the email header becomes the email campaign name. In addition, the email analysis server application 255 automatically generates a campaign identifier (“campaign ID”) for that campaign. As other email clients report internet headers from the same email message (and thus same email campaign), the email analysis server application 255 adjusts the statistics for that email campaign. In one embodiment, the email analysis server application 255 may increment statistics that specify when the email messages are viewed in a list of email messages and when such email messages are opened. Additional statistics related to the email messages can also be maintained.

As set forth above, the email header analysis may be performed in real-time as email header information is received or the email analysis server application 255 may simply store the header information received for all the messages it is interested into email activity database 259. Later, the contents logged into the email activity database 259 will be analyzed on a non real-time basis. For example, in one embodiment, the email analysis server application 255 creates a new email activity database 259 for each twenty-four hour period. At the end of a twenty-four hour period, a new email activity database is created and the data from the previous new email activity database is then analyzed.

As set forth earlier, one embodiment uses the contents of the “From:”, “Subject:”, and “Date:” fields of the email headers to identify email campaigns. The “From:” and “Date:” fields are available in every properly formatted internet email message according to the internet headers requirements of RFC 2822. The “Subject:” field is not a required header but if a “Subject:” field exists only one may be present. All three of these email header fields are available at any point along the email messages transit from source to final destination. If these three email header fields are judged to be substantially the same for different email messages, then those email messages are determined to be from the same email campaign.

Note that these internet email header fields may vary to some degree and still be considered ‘substantially the same’. For example, the email server that sends out the messages may be slow such that the values in the date field will differ. Thus, the comparison system for determining if different email messages are from the same email campaign should have some tolerance of differences. Possible implementations of these tolerances are presented below.

With regard to the contents of the “Date:” field, a tolerance may be specified using a threshold time difference. For example, email messages that are not sent within the same 4 hours or not sent within the same day may not be considered as messages from the same campaign. Email messages within the specified time threshold (4 hours or 1 day in these examples) may be considered from the same campaign depending on the comparisons of the other fields. To start out, a default threshold value could be assigned to each sending company. As the system processes email from the company, and analyzes it, the system can self-adjust the threshold value. In this manner, each company can have a threshold that is most optimum for it.

The content of the “Subject:” field is often exactly the same for all mail recipients who are sent messages from the same email campaign. However, there are occasions when this is not true. For example, the subject field may be personalized by including the recipient's first name. Or similar messages of the same type may be considered the same even though the deal with different matters. For example, all order confirmation messages may be considered part of the same “campaign” such that an email with the subject “Order Confirmation #2131” should be part of the same campaign as an email with the subject “Order Confirmation #4383”. (The order number is different for each user.) To handle such differences in the “Subject:” field, the system may only require the first N characters to be the same wherein N is a value that may be specified.

In an alternate embodiment, the system could perform a complex string comparison that outputs a percentage difference value that specifies how different the strings are from each other on a percentage basis. With such an embodiment, the percentage difference could be compared with a threshold value such as 85% to determine if the subject fields are close enough to possibly be from the same campaign.

In yet another alternate embodiment, the system may parse the contents of the “Subject:” field into an array of words. The system may then look for matches based on the words. The system could then mark the words that matched and their position. The system could then determine if the fields have the same pattern by considering factors such as 1) matching and non-matching words, 2) word positions, and 3) number of words to determine if the different email messages have essentially the same subject. For example, the follow two subject lines could be determined to be from the same email campaign since most of the words match and there is the same number of words.

Subject: Hey Bob, your order has been shipped!

Subject: Hey Ketan, your order has been shipped!

The following table lists Array of words (showing their positions)

| 1 | 2 | 3 | 4 | 5 | 6 | 7 |
|---|---|---|---|---|---|---|
| Hey | Bob, | Your | Order | Has | Been | Shipped! |
| Hey | Ketan, | Your | Order | Has | Been | Shipped! |

The pattern followed by these two subjects is: MNMMMMM [7]. Where M=Matching word, N=Non-matching word and [7] is the number of words. Email messages with words in the Subject: field that match/don't match in the same pattern can be considered to have the (substantially) same subject.

“String comparison” is another (simpler) pattern matching algorithm:

Subjects with the first N matching words/characters can be considered the same

Subjects with X% of the words/characters matching can be considered the same

Pattern matching algorithms can be refined to account for singular and plural forms of the same word, past or future tenses, stop words, numbers, and others that may all be used for this pattern matching task.

With regard to the “From:” field there may not be much need for tolerance. For example, one embodiment would require an exact match of the email address in the “From:” address to be considered part of the same email campaign. In another embodiment the system may consider closely matching addresses in the “From:” field. For example, a company may have a global user base that is sent the same message. However, the company's mail servers may send out email grouped by region. Thus, the “From:” email address seen by a recipient in United Kingdom (UK) may be different from the “From:” address seen by a recipient in United States of America (USA). For example, a company named “Retailer” may send out the same email message but the recipients in the UK and the recipients in the USA may receive the following two different “From:” addresses, respectively:

From: Sales@Retailer.co.uk

From: Sales@Retailer.com

In this case, a pattern match of the field “From:” with some tolerance is more effective than a strict exact text match. In another embodiment, the system could require that the value in the “From:” field match the string before the ampersand (“@”) and the next one or two portions of the domain field after the ampersand. Referring to the preceding example, the system would match the “Sales@Retailer” portion of the “From:” field value.

In one embodiment, the comparison parameters for the “Subject:” and “Date:” fields may be set differently for different customers. Specifically, the system would first examine the contents of the “From:” field to determine which particular customer this message is related to. The system would then look up a set of tolerance parameters to apply when comparing the subject and date fields. In this manner, different customers may specify different threshold values for determining when email messages are from the same email campaign or not. Some customers may want only messages sent out on the same day to be part of a single email campaign. Other customers may allow email campaigns to extend over several days but have strict differentiations in the subject field to identify different email campaigns.

In one embodiment, fuzzy logic may be applied to determine if messages are from the same campaign. For example, each different header field comparison could yield a score value. The score values would then be totaled up and if the total score exceeded a threshold value then the messages are considered part of the same campaign. For example, FIGS. 3A to 3C illustrate scoring graphs that could be used to generate a score value (usually in the range from zero to one) for each of the three fields. The three scores would be added together and compared with a threshold value (such as 2.5 for this example) to determine if the email messages are similar enough to be part of the same campaign. Note that in the scoring graph for the “From:” field illustrated in the example embodiment of FIG. 3A requires an exact match for the “From:” field for a possible email campaign match.

Email Campaign Tracking

As set forth in the previous sections, the mail client or mail monitor that reports to the email analysis server application 255 can report any information that it has available about messages that the email analysis server application 255 is interested in. For example, a mail client program may report when a message is viewed so the email sender can see how long it takes recipients to read their messages. When a mail client authenticates email messages, the mail client can report if there was any difficulty in authenticating the message to the email analysis server application 255.

One interesting twist to this system is that if a malicious entity is attempting to spoof (trick) email recipients using the email address of a customer of the email monitor server 250, this system will track all of those email address spoof attempts. Thus, not only will customers be able to track their own email campaigns but they will be able to track the spoof campaigns executed by malicious entities using their “From:” address in an unauthorized manner. Furthermore, the mail client or mail monitor program can be requested to send the all information related to such spoof messages to the email analysis server application 255 such that any attempt to track down such malicious entities will be facilitated.

Possible Modifications

The method of tracking email campaigns using email header information can be combined with the previously existing approaches. Such implementations can provide additional benefits.

As set forth earlier, one method of tracking email messages is to embed images in an HTML message that will be accessed when a client program opens the message and displays the image. Thus, if the system is used with such an embedded image, the system can determine not only when an email message has been viewed but when an email message has been viewed with all of the full imagery that may be contained embedded the email message. Furthermore, the email client may scan the body of the email message for a link to such an embedded image file. If found, the name of that image file may be used as the email campaign name, campaign identifier, or other purpose.

This latter technique may also be used with X-headers. Specifically, the email client may scan the message for a recognized X-header. The content of that X-header may then be used for the campaign name, campaign identifier, or other purpose. This allows the analysis server application 255 to breakdown email campaign performance reports using the same campaign identifier that the company had assigned in the X-Header. In such an embodiment, only the mail sender program and the mail client program (or mail monitor program) need to know about the usage of the X-header format. All intermediate mail servers would transport the X-header untouched. In embodiments wherein the mail client (or the mail monitor) submits email origin information and then requests email analysis server application 255 for additional instructions, the client only needs to be able to understand instructions that request it to send a particular header from the message. Thus, the email analysis server application 255 would determine whether (and which) X-headers are needed. Note that system allows some customers to name their own email campaigns if desired while other customers will have email campaign names automatically determined as set forth earlier.

The preceding description is intended to be illustrative, and not restrictive. For example, the above-described embodiments (or one or more aspects thereof) may be used in combination with each other. Other embodiments will be apparent to those of skill in the art upon reviewing the above description. The scope of the claims should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract is provided to comply with 37 C.F.R. §1.72(b), which requires that it allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment.

What is claimed is:

1. A method of detecting an internet email campaign, said method comprising:
receiving from a plurality of sources, a set of email message headers from email messages;
comparing said set of email message headers received from said plurality of sources with each other; and
identify email message headers having similar email message headers as belonging to a single email campaign.

2. The method of detecting an internet email campaign as set forth in claim 1 wherein said similar email message headers comprises email message headers having a datestamp within a threshold time amount of each other.

3. The method of detecting an internet email campaign as set forth in claim 1 wherein said similar email message headers comprises a matching email address.

4. The method of detecting an internet email campaign as set forth in claim 1 wherein said similar email message headers comprises a subject field having at least a threshold number of matching characters.

5. The method of detecting an internet email campaign as set forth in claim 1 wherein said similar email message headers comprises email message headers having a similar origin, a similar time, and a similar subject.

6. The method of detecting an internet email campaign as set forth in claim 5 wherein said set of email message headers comprises contents from a “From:” field, a “Subject:” field, and “Date:” field.

7. The method of detecting an internet email campaign as set forth in claim 1 wherein one of said plurality of sources comprises a mail client program executing on a user's computer system.

8. The method of detecting an internet email campaign as set forth in claim 1 wherein one of said plurality of sources comprises a mail monitor program executing on a mail server local to an email campaign recipient.

9. The method of detecting an internet email campaign as set forth in claim 1 wherein one of said plurality of sources comprises a mail monitor program executing on a mail server local to an email campaign sender.

10. A computer-readable medium, said computer-readable medium comprising a set of computer instructions for detecting an internet email campaign, said computer instructions implementing:
receiving from a plurality of sources, a set of email message headers from email messages;
comparing said set of email message headers received from said plurality of sources with each other; and
identify email message headers having similar email message headers as belonging to a single email campaign.

11. The computer-readable medium as set forth in claim 10 wherein said similar email message headers comprises email message headers having a datestamp within a threshold time amount of each other.

12. The computer-readable medium as set forth in claim 10 wherein similar said email message headers comprises a matching email address.

13. The computer-readable medium as set forth in claim 10 wherein said similar email message headers comprises a subject field having at least a threshold number of matching characters.

14. The computer-readable medium as set forth in claim 10 wherein said email message headers having similar email message headers comprises email message headers having a similar origin, a similar time, and a similar subject.

15. The computer-readable medium as set forth in claim 10 wherein one of said plurality of sources comprises a mail client program executing on a user's computer system.

16. The computer-readable medium as set forth in claim 10 wherein one of said plurality of sources comprises a mail monitor program executing on a mail server local to an email campaign recipient.

17. A system for detecting an internet email campaign, said system comprising:
a receiving module, said receiving module receiving from a plurality of sources, a set of email message headers from email messages;
an email campaign identifier module, said email campaign identifier module comparing said set of email message headers received from said plurality of sources with each other and identify email message headers having similar email message headers as belonging to a single email campaign.

18. The system for detecting an internet email campaign as set forth in claim 17 wherein said similar email message headers comprises email message headers having a datestamp within a threshold time amount of each other.

19. The system for detecting an internet email campaign as set forth in claim 17 wherein similar email message headers comprises a matching email address.

20. The system for detecting an internet email campaign as set forth in claim 17 wherein similar email message headers comprises a subject field having at least a threshold number of matching characters.

21. The system for detecting an internet email campaign as set forth in claim 17 wherein said email message headers having similar email message headers comprises email message headers having a similar origin, a similar time, and a similar subject.

22. The system for detecting an internet email campaign as set forth in claim 17 wherein one of said plurality of sources comprises a mail client program executing on a user's computer system.

23. The system for detecting an internet email campaign as set forth in claim 17 wherein one of said plurality of sources comprises a mail monitor program executing on a mail server local to an email campaign recipient.

24. The system for detecting an internet email campaign as set forth in claim 17 wherein one of said plurality of sources comprises a mail monitor program executing on a mail server local to an email campaign sender.

25. The system for detecting an internet email campaign as set forth in claim 17 wherein said receiving module stores said set of email message headers in a database for later processing and said email campaign identifier module processes said set of email message headers when said receiving module closes said database and creates a new database for subsequent email message headers.
